(19) United States
(12) Patent Application Publication
(10) Pub. No.: US 2007/0188951 A1
(43) Pub. Date: Aug. 16, 2007

(54) Optoelectronic device ESD protection

(76) Inventor: Darren S. Crews, Santa Clara, CA (US)

Correspondence Address: INTEL CORPORATION;c/o INTELLEVATE, LLC, P.O. BOX 52050, MINNEAPOLIS, MN, 55402, US

(21) Appl. No.: 11/351,681

(22) Filed: Feb. 10, 2006

(51) Int. Cl. H02H 9/00

(52) U.S. Cl. 361/56

(57) ABSTRACT

A method and apparatus for electrostatic discharge protection for an optoelectronic device driven by an electrical link driver is provided. An AC coupled positive output of a differential mode electrical link driver is wire-bonded to an electrostatic discharge protector. The electrostatic discharge protector includes dual diodes for discharging electrical current resulting from an electrostatic discharge. In one embodiment, the electrostatic discharge protector protects the optoelectronic device from a 2 kV discharge per the human body model.

### FIELD

This disclosure relates to optoelectronic devices and in particular to electrostatic discharge protection for an optoelectronic device driven by an electrical link driver.

### BACKGROUND

A laser is a light source used for communications over optical fibre. One well-known laser is a Vertical Cavity Surface Emitting Laser (VCSEL) which may be used in short distance, high speed networking interfaces that use Ethernet and Fibre Channel networking protocols. The VCSEL light source is a coherent symmetrical low divergence optical beam. Typically, the wavelength is about 850 nanometers (nm).

VCSELs are inherently sensitive to Electrostatic Discharge (ESD), that is, the transfer of static electricity between bodies at different electrical potentials. A person walking across a vinyl tile floor may generate about 250 volts (V) of static electricity when there is more than 65% relative humidity and more than 12,000V of static electricity when there is about 25% relative humidity. This static electricity may be discharged through an electronic component through direct contact or an ionized ambient discharge (spark). Static electricity that is discharged through an electronic component can cause catastrophic failures in the electronic component or latent defects that may develop into intermittent failures later.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of an embodiment of a transmitter that includes a laser and an electrostatic discharge protector according to the principles of the present invention;

FIG. 2 is a circuit diagram of an embodiment of the electrostatic discharge protector shown in FIG. 1;

FIG. 3A shows an eye diagram of the input signal to the electrostatic discharge protector as it is received from the output of a Peripheral Component Interconnect Express driver;

FIG. 3B shows an eye diagram of the output signal from the electrostatic discharge protector as it is received by the anode of a Vertical Cavity Surface Emitting Laser;

FIG. 4 illustrates the frequency response for the embodiment of the transmitter shown in FIG. 2;

FIG. 5 is a circuit diagram of another embodiment of the electrostatic discharge protector shown in FIG. 1;

FIG. 6 is a block diagram of an embodiment of a computer system that includes electrostatic discharge protection for an optoelectronic device according to the principles of the present invention; and

FIG. 7 is a flowchart of an embodiment of a method for providing ESD protection implemented by the ESD protector shown in FIG. 2.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

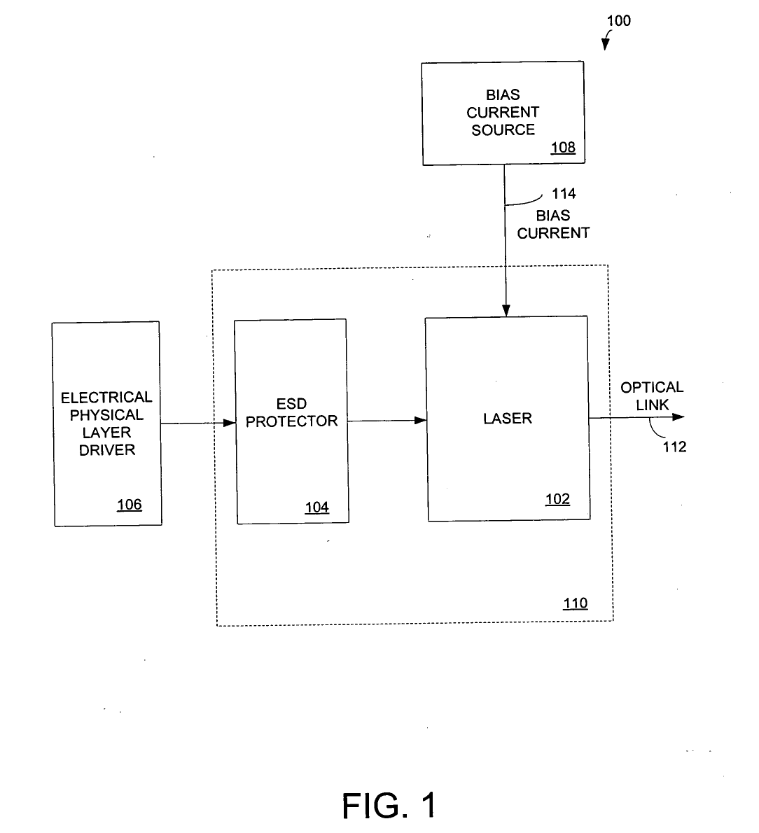

FIG. 1 is a block diagram of an embodiment of a transmitter 100 that includes a laser 102 and an electrostatic discharge (ESD) protector 104 according to the principles of the present invention. A laser (light amplification by stimulated emission of radiation) is a device that uses certain quantum effects to produce coherent light. The laser 102 converts electrical current into a corresponding light signal which may be used to transmit data through optical link 112. The laser 102 can be modulated (turned on and off) at high speed which is measured by the time required to go from 10% to 90% of peak power. The laser 102 may be a semiconductor laser such as a Vertical Cavity Surface Emitting Laser (VCSEL), a Fabry Perot (FP) laser diode, a Distributed Feedback (DFB) laser diode, a Light Emitting Diode (LED), a Resonant Cavity (RCLED), or the like. However, these are merely examples of lasers and embodiments of the present invention are not limited in these respects.

The laser 102 is typically coupled to a customized laser driver which provides modulation current that switches the power level of the laser output between a high value and a low value. The power level is interpreted as either a logical 1 (high level) or logical 0 (low level) by a receiving device coupled to the optical link 112. The laser driver is typically customized for driving a particular laser and includes electrostatic discharge protection (ESD) on all of the input/output signals.

Lasers are inherently sensitive to ESD, that is, the transfer of static electricity between bodies at different electrical potentials. The electrical potential of an object is expressed as a voltage and the charge on an object (measured in coulombs) is determined by the product of capacitance and the voltage. The amount of charge is affected by the area of contact, the speed of separation and relative humidity. A device's sensitivity to ESD is dependent on a device's ability to dissipate the charge or withstand the voltage levels.

The transfer of static electricity referred to as an ESD event may be through direct contact or an ionized ambient discharge (spark). The human body model is used to simulate direct transfer of electrostatic charge from the human body to a device. The human body model is modeled by a 100 pico Farad (pF) capacitor discharged through a switching component and a 1.5 kilo (K) ohm resistor into the device and represents the discharge from the fingertip of a standing human delivered to the device. The human body model is used in ESD Association standard ESD STM5.1: Electrostatic Discharge Sensitivity Testing—Human Body Model ESD Association, Rome, N.Y. Laser diodes typically have sensitivity levels that range from 0-2 kilo Volts (kV).

The laser driver protects against an ESD event because the laser driver input goes through an intermediate circuit that does not pass an ESD event through to the laser. In the embodiment shown, the laser 102 is driven by an electrical physical layer driver 106 instead of a conventional laser driver. The electrical physical layer driver 106 is designed to drive a point-to-point link using a differential-mode signal. As discussed in commonly owned co-pending U.S. application Ser. No. 11/165,298 entitled “Driving a Laser using an Electrical Link Driver”, the electrical physical layer driver 106 may be directly coupled to a laser 102 to provide modulation current for the laser 102.

The electrical physical layer driver 106 that is used for driving a differential-mode signal does not provide the same level of ESD protection provided by a laser driver. Furthermore, there may be intermediate traces between the output of the electrical physical layer driver 106 and the laser 102 through which there may be an electrostatic discharge (ESD event) which may be transmitted to the laser 102.

An embodiment of an ESD protector 104 according to the principles of the present invention is coupled between an electrical physical layer driver 106 and the laser 102 to provide ESD protection for the laser 102. The ESD protector 104 diverts the potentially damaging static current away from the laser 102 in order to protect the laser 102 from permanent damage resulting in a catastrophic failure or latent defect. In one embodiment, the ESD protector 104 is coupled between the output of the electrical physical layer driver 106 and the anode of the laser 102.

In a laser, an optical output may be generated when the input current is maintained above a threshold current level. The input current includes a modulation current provided by the electrical physical layer driver 106 through ESD protector 104 and a bias current 114 provided by a bias current source 108. The bias current 114 is supplied by the bias current source 108 to the laser 102 to keep the laser 102 above the threshold current level in order to avoid delay in turning on the laser 102.

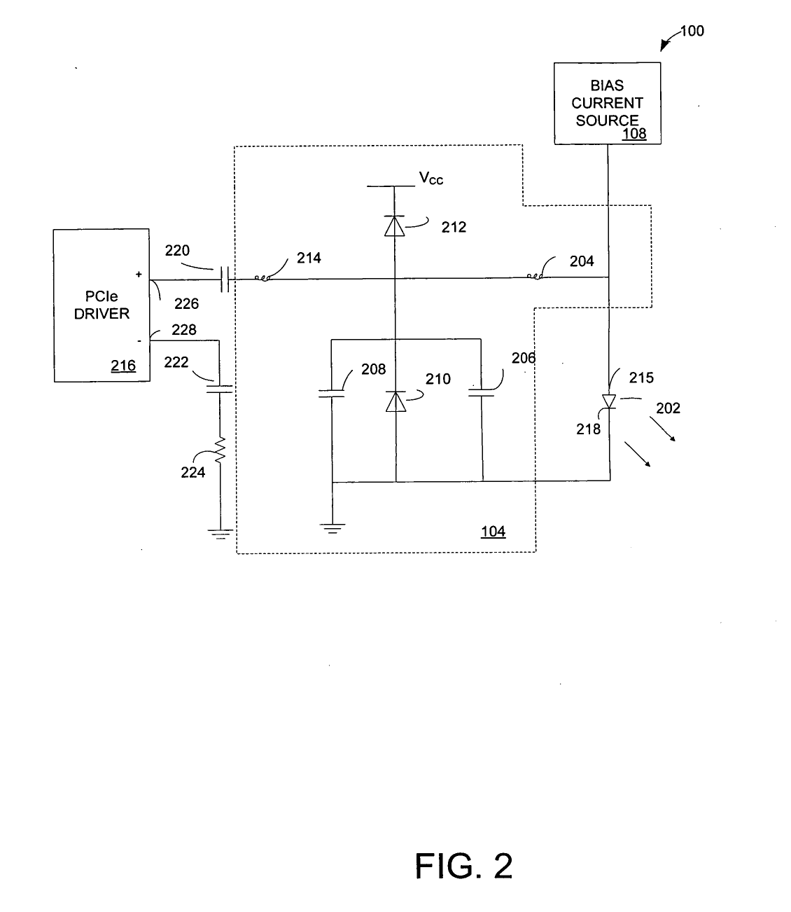

FIG. 2 is a circuit diagram of an embodiment of the ESD protector 104 shown in FIG. 1. The ESD protector 104 includes dual electrostatic protection diodes 212, 210, with electrostatic protection diode 212 coupled between V_{cc} and the anode 215 of the laser 202 through wire-bond 204 and electrostatic protection diode 210 coupled between ground and the anode of electrostatic protection diode 212. The cathode 218 of the laser 202 is also connected to ground. The dual ESD diodes 212, 210 route the ESD current to Vcc or to ground dependent on whether the electrostatic charge to be discharged is positive or negative.

In the embodiment shown, the electrical physical link driver 102 shown in FIG. 1 is a Peripheral Component Interconnect Express (PCIe) driver 216. The PCIe driver 216 is one of the components in the physical layer of the PCIe standard defined in the Peripheral Component Interconnect Express Base Specification Revision 1.0a, Apr. 15, 2003 available at www.pcisig.com. The physical layer transports packets between the link layers of two PCIe agents.

The basic PCIe physical layer includes a dual simplex channel implemented as a transmit pair and a receive pair. The transmit pair and receive pair are low-voltage AC-coupled differential pairs of signals. The electrical physical layer driver output is a differential-mode signal, that is, the output of the driver comprises two wires (shown as a positive (+) terminal 226 and a negative (−) terminal 228 in FIG. 2), with the difference in voltage between the two terminals representing a logical 0 or a logical 1 dependent on which of the two outputs has the higher voltage level. For example, a 3V differential-mode signal results when one of the terminals has a voltage of 4V and the other terminal has a voltage of 1V. The differential peak-to-peak voltage of the PCIe driver differential mode output ranges from about 0.8V (min) to about 1.2V (max).

The PCIe driver 216 provides a differential mode output on a positive terminal 226 and a negative terminal 228. The positive terminal 226 is coupled to one side of an Alternating Current (AC) coupling capacitor 220 to isolate Direct Current (DC) levels. The other end of AC coupling capacitor 220 is coupled to one end of wire bond 214.

In the embodiment shown in FIG. 2, the laser 102 shown in FIG. 1 is a Vertical Cavity Surface Emitting Laser (VCSEL). A VCSEL 202 is a laser structure that includes an electrically pumped active region which emits laser light vertically from the surface of the VCSEL. Mirrors formed of layers of semiconductor materials located above and below the active region reflect light emitted from the active region to provide light emission. In one embodiment, the VCSEL is a 2.5 Giga bits per second (Gbp/s), 850 nanometers (nm) VCSEL (Emcore Corporation, part number 8585-1025). However, this is merely an example of a VCSEL and embodiments of the present invention are not limited in this respect.

In the embodiment shown in FIG. 2, the PCIe driver 216 drives the VCSEL 202 in single-ended mode, that is, only the positive terminal 226 of the PCIe driver 216 is used to drive the VCSEL 202. The negative terminal 228 of the PCIe driver 216 is terminated to ground through AC coupling capacitor 222 and termination resistor 224 to provide a balanced load on the outputs of the PCIe driver 216. In one embodiment termination resistor 224 is 50 ohms and the AC coupling capacitor 228 has a capacitance between 75 nano Farad (nF) and 200 nF.

The positive terminal 226 of the PCIe driver 216 provides modulation current to the VCSEL 202 through the AC coupling capacitor 220 and electrostatic protector 104. The VCSEL 202 receives modulation current from the PCIe driver 216 and bias current from the bias current source 108. This combined current is converted to light which is transmitted over an optical link 112 which may be an optical fiber, or other types of waveguides, such as a polymer or glass waveguide.

An optical fiber typically includes a core, cladding, and a coating or buffer. The core of the fiber is a cylindrical rod of dielectric material through which light propagates. The core is surrounded by a layer of material that is referred to as the cladding. The optical fibre is not limited to polymer or glass, for example, it may be made out of silicon. A waveguide may be made from any material where a core material has an index of refraction which is higher than the cladding material.

In the embodiment shown, the PCIe driver 216 is coupled to the VCSEL 202 through the ESD protector 104. The ESD protector 104 has a first bond pad that includes an ESD protector having two ESD diodes 212, 210. The capacitor 208 represents the capacitance of the first bond pad which is typically about 70×10⁻¹⁵ femto Farad (fF). The ESD protector 104 has a second bond pad having a bond capacitance of about 70 fF, which is represented by capacitor 206. In one embodiment the ESD diodes 212, 210 are similar to ESD diodes that are used to protect a high speed input or output stage in an integrated circuit. For example, the ESD diodes may be p-n junction based or Metal-Oxide-Semiconductor (MOS) based.

The output of the PCIe driver 216 is bonded to the first bond pad through wire bond 214. In one embodiment, wire bond 214 has an inductance of about 1 nano Henry (nH). The anode 215 of the VSCEL 202 is coupled via another wire bond 204 to the second bond pad.

Through the ESD diodes 212, 210 in the ESD protector 104, the VCSEL 202 can tolerate undershoot and overshoot voltage of short duration due to an ESD event. The electrostatic charge is dissipated by sinking the associated current through one of the ESD diodes 212, 210 to protect the ESD sensitive VCSEL. ESD diode 210 is coupled between the anode of VCSEL 202 through wire bond 204 and ground in reverse direction to the VCSEL 202. As an ESD diode sinks current when forward biased, ESD diode 210 will sink current when there is a negative voltage that forward biases ESD diode 210 and ESD diode 212 will sink current when there is a positive voltage that forward biases ESD diode 212. Thus, ESD diode 210 protects against discharge of a positive electrostatic voltage and ESD diode 212 protects discharge of a negative electrostatic voltage.

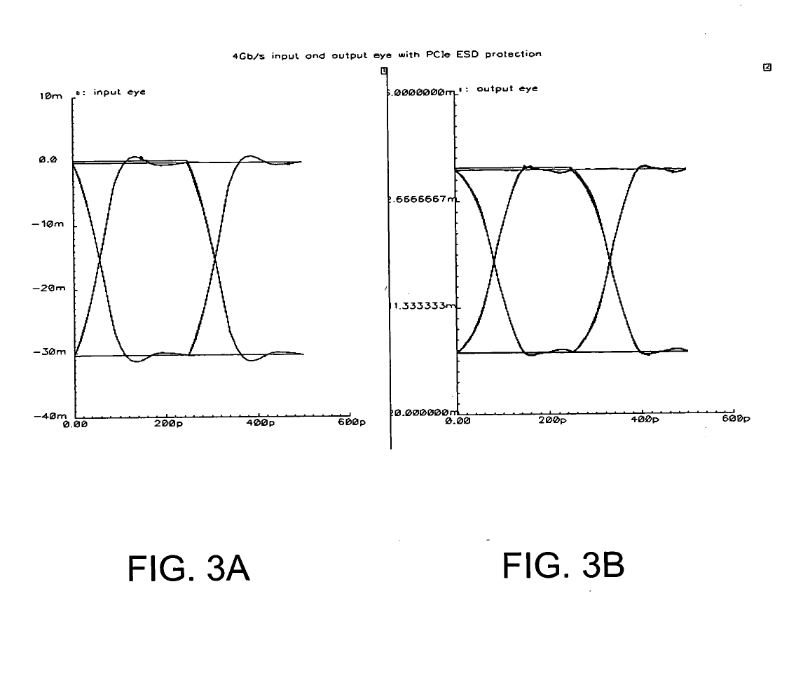

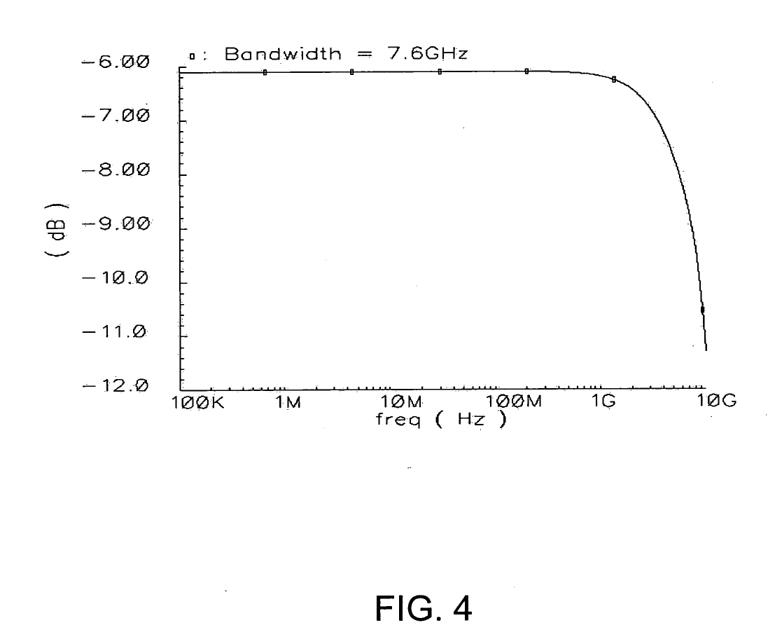

The addition of the ESD protector 104 between the positive terminal 226 of the PCIe driver 216 and the anode 215 of the VCSEL 202 results in minimal performance degradation. FIGS. 3A-B and FIG. 4 illustrate the results of simulation of the circuit shown in FIG. 2, with wire bonds 204, 214 modeled as 1 nH inductors and bond pad capacitance 208, 206 modeled as 70 fF.

FIG. 3A shows an eye diagram of the input signal to the ESD protector 104 as it is received from the output of the PCIe driver 226 and FIG. 3B shows an eye diagram of the output signal from the ESD protector 104 as it is received by the anode 215 of the VCSEL 202. The input and output signals are at 4 Gigabits per second (Gb/s).

As shown in FIGS. 3A-B, although the ESD protector 104 adds a load capacitance to the output signal dependent on the parasitics of the ESD diodes 210, 212, this load capacitance does not limit the ability of the output signal to switch quickly at 4 Gb/s.

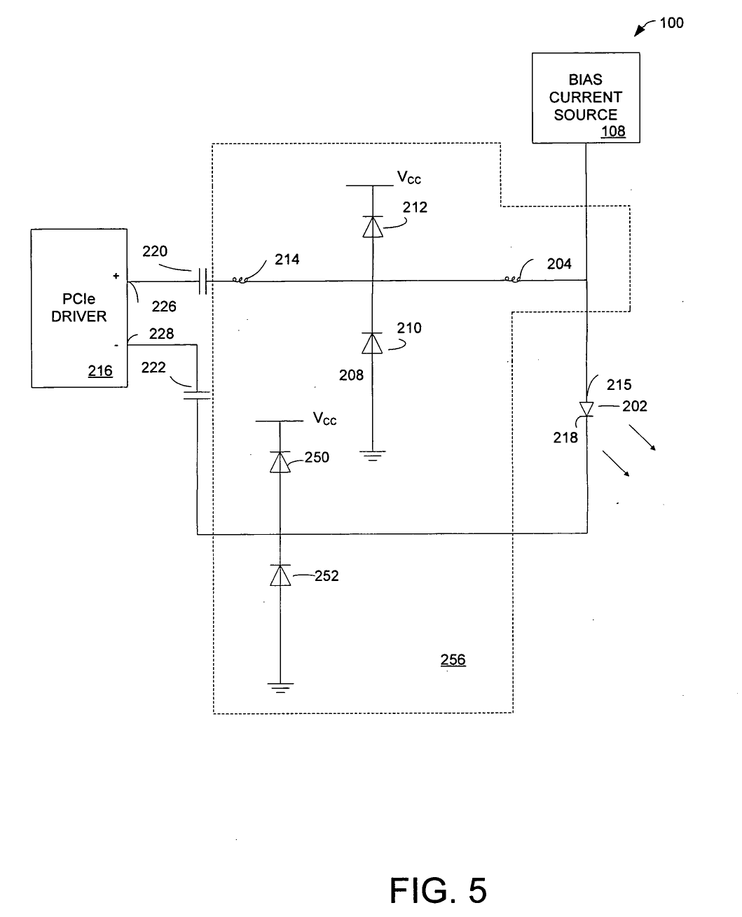

FIG. 4 illustrates the frequency response for the circuit shown in FIG. 3 with p-n junction type ESD diodes. The x-axis of the graph is the frequency in hertz (Hz) and the y-axis is the loss in power measured in decibels (dB). As shown in FIG. 5, the bandwidth is 7.6 GHz and there is no peaking or resonance.

FIG. 5 is a circuit diagram of another embodiment of the electrostatic discharge protector shown in FIG. 1. In the embodiment shown in FIG. 5, ESD protector 256 provides ESD protection to both the cathode 218 of the laser 102 and to the anode 215 of the laser 102. The ESD protector 256 includes dual electrostatic protection diodes 212, 210 with electrostatic protection diode 212 coupled between V_{cc} and the anode 215 of the VCSEL 202 through wire bond 204 and electrostatic protection diode 210 coupled between the anode 215 of the VCSEL 202 through wire bond 204 and ground. The ESD protector 256 also includes dual electrostatic protection diodes 250, 252, with electrostatic protection diode 250 coupled between the cathode 218 of VSCEL 202 and V_{cc} and electrostatic protection diode 252 coupled between the cathode 218 of the laser 202 and ground. The dual electrostatic diodes 212, 210, 250, 252 route the ESD current to V_{cc} or ground dependent on whether the electrostatic charge to be discharged is positive or negative.

The ESD protector 256 protects the VCSEL 202 from an electrostatic discharge of at least +2 kV, −2 kV per the human body model. An embodiment of the invention having an ESD protector 256 with p-n type diodes was tested. The ESD protector 256 was coupled to the anode 215 of the VCSEL 202 and to the cathode 218 of the VCSEL 202 as shown in FIG. 5. The leads connected to the anode and cathode of the VCSEL 202 were subjected to an electrostatic discharge of +2 kV and −2 kV, with each ESD event occurring five times, using a human body model gun. The VCSEL 202 underwent a 24 hour burn in test after each set of five ESD discharges which found no degradation in the VCSEL 202.

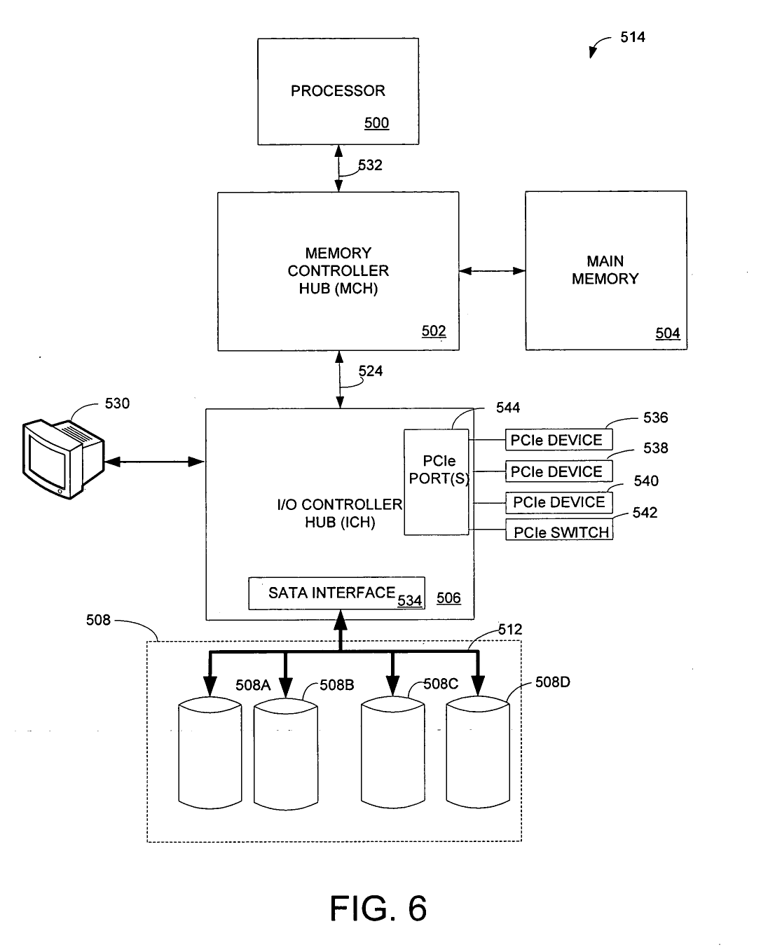

FIG. 6 is a block diagram of an embodiment of a computer system 514 that includes electrostatic discharge protection for an optoelectronic device according to the principles of the present invention. The computer system 514 includes, a processor 500 and a chipset that includes an Input/Output (I/O) Controller Hub (ICH) 506 and a Memory Controller Hub (MCH) 502. The MCH 502 manages a memory 504 that is coupled to the MCH 502. In one embodiment, the memory 504 is a 64-bit wide double data rate (DDR2) memory. The processor 500 is coupled to the MCH 502 by a host interface 532. The MCH 502 is coupled to the ICH 506 by a high-speed direct media interface 524. The ICH 506 manages I/O devices including storage devices coupled to a storage interface.

In one embodiment, a storage controller in the ICH 506 manages Serial Advanced Technology Attachment (SATA) devices 508 coupled to a SATA bus 512. The SATA protocol is a standard serial storage protocol available at www.sata-io.org. In an embodiment, the I/O controller hub (ICH) 506 includes a Serial Advanced Technology Attachment (SATA) interface 534 that includes four ports each of which may be coupled to a SATA device 508A-B such as, a disk drive or other storage device.

ICH 506 may also include PCIe interface 544 including PCIe links for general purpose input/output applications such as communications and storage. While the embodiment shown in FIG. 6 shows an ICH 506 having four PCIe ports capable of being coupled to PCI devices 536, 538, 540 and PCIe switch 542, it will be understood that embodiments of the present invention are not limited to an ICH 506 having four PCIe ports.

Each PCIe link may be used to implement a combination of PCI mini card sockets, slots for ExpressCard modules, and other PCIe devices. A PCIe switch 542 may be added to increase the number of PCIe ports. Each PCIe link includes a differential signal pair having a receive pair and a transmit pair as discussed earlier in conjunction with FIG. 2.

The computer system 514 may also include a display 530 coupled to the ICH 506 for displaying user interfaces. The display 530 may comprise a cathode ray tube display, a solid state display such as a liquid crystal display, a plasma display, or a light-emitting diode display, among others.

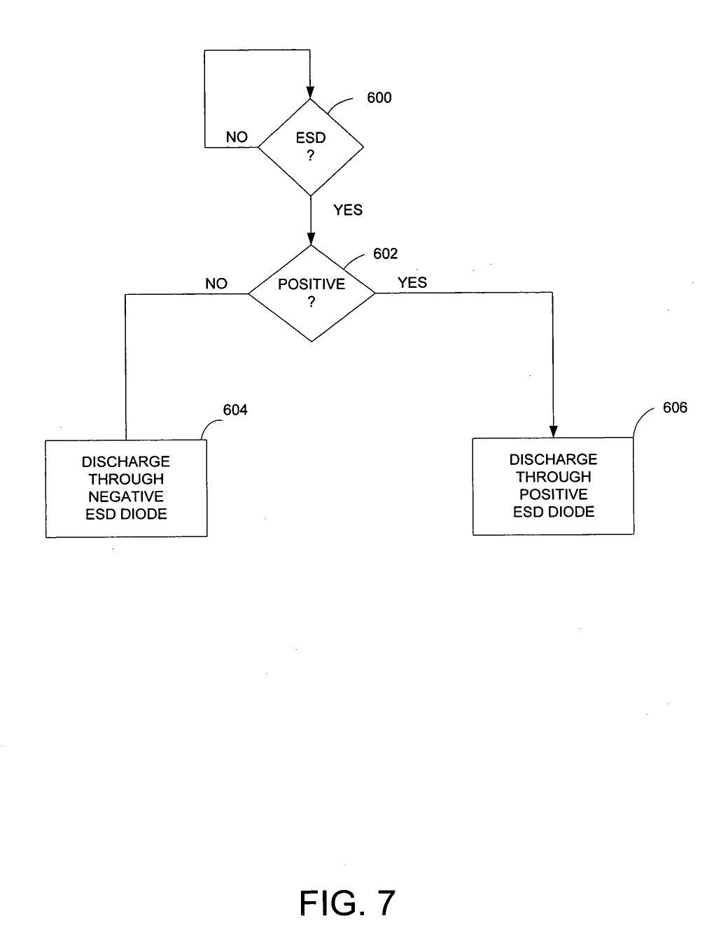

FIG. 7 is a flowchart of an embodiment of a method for providing ESD protection implemented by the ESD protector 104 shown in FIG. 2.

At block 600, the ESD protector 104 waits for an ESD event. Upon detecting an ESD event, processing continues with block 602.

At block 602, an ESD event is detected and there is a static voltage detected at the anode of ESD diode 212. If the detected static voltage is positive, processing continues with block 606. If the detected static voltage is negative, processing continues with block 604.

At block 604, current generated by the discharge of the negative static voltage is directed through ESD diode 210.

At block 606, current generated by the discharge of the positive static voltage is directed through ESD diode 212

While embodiments of the invention have been particularly shown and described with references to embodiments thereof, it will be understood by those skilled in the art that various changes in form and details may be made therein without departing from the scope of embodiments of the invention encompassed by the appended claims.

What is claimed is:

1. An apparatus including:
a laser; and
an electrostatic discharge protector coupled to an anode of the laser, the electrostatic discharge protector capable of shunting excess current resulting from an electrostatic discharge away from the anode of the laser.

2. The apparatus of claim 1, wherein a modulation signal is coupled to the anode of the laser through the electrostatic discharge protector.

3. The apparatus of claim 1, wherein the electrostatic discharge protector is an integrated circuit.

4. The apparatus of claim 1, wherein the anode of the laser is wire bonded to an output of the electrostatic discharge protector.

5. The apparatus of claim 1, wherein the laser is a Vertical Cavity Surface Emitting Laser.

6. The apparatus of claim 1, wherein a cathode of the laser is coupled to the electrostatic discharge protector.

7. The apparatus of claim 1, further comprising:
an electrical physical layer driver having a positive terminal coupled to the electrostatic discharge protector, the electrical physical layer driver providing modulation current to the laser through the electrostatic discharge protector.

8. A method comprising:
providing electrostatic discharge protection for a laser by coupling an an electrostatic discharge protector to an anode of the laser; and
upon detection of an electrostatic discharge, shunting excess current resulting from an electrostatic discharge away from the anode of the laser.

9. The method of claim 8, wherein a modulation signal is coupled to the anode of the laser through the electrostatic discharge protector.

10. The method of claim 8, wherein the electrostatic discharge protector is an integrated circuit.

11. The method of claim 8, wherein the anode of the laser is wire bonded to an output of the electrostatic discharge protector.

12. The method of claim 8, wherein the laser is a Vertical Cavity Surface Emitting Laser.

13. The method of claim 8, wherein a cathode of the laser is coupled to the electrostatic discharge protector.

14. The method of claim 8, further comprising:
providing modulation current to the laser from an electrical physical layer driver coupled to the electrostatic discharge protector.

15. A system including:
a liquid crystal display; and
a chipset coupled to the liquid crystal display, the chipset including:
a laser; and
an electrostatic discharge protector coupled to an anode of the laser, the electrostatic discharge protector capable of shunting excess current resulting from an electrostatic discharge away from the anode of the laser.

16. The system of claim 15, wherein a modulation signal is coupled to the anode of the laser through the electrostatic discharge protector.

17. The system of claim 15, wherein the electrostatic discharge protector is an integrated circuit.

18. The system of claim 15, wherein the anode of the laser is wire bonded to an output of the electrostatic discharge protector.

19. The system of claim 15, wherein the laser is a Vertical Cavity Surface Emitting Laser.
